(19) United States
(12) Patent Application Publication
(10) Pub. No.: US 2025/0139566 A1
(43) Pub. Date: May 1, 2025

(54) METHOD FOR MANAGING THE LOAD SPACE OF A DELIVERY VEHICLE, LOAD SPACE MANAGEMENT SYSTEM, AND DELIVERY VEHICLE

(71) Applicant: Ford Global Technologies, LLC, Dearborn, MI (US)

(72) Inventors: Abhinav Dhake, Meerbusch (DE); Roy Hendrikx, Limburg (BE); Mark Gijbels, Kessel-lo (BE); Nicole Leonarda Wilhelmina Eikelenberg, Meerssen (NL); Jeroen Lem, Wittem (NL); Detlef Kuck, Inden (DE); Walter Pijls, Oirsbeek (NL); Alexandra Holz, Aachen (DE)

(73) Assignee: Ford Global Technologies, LLC, Dearborn, MI (US)

(21) Appl. No.: 18/922,699

(22) Filed: Oct. 22, 2024

(30) Foreign Application Priority Data
Oct. 26, 2023 (DE) 102023129580.2

(51) Int. Cl. G06Q 10/083

(52) U.S. Cl. CPC G06Q 10/083

(57) ABSTRACT

The disclosure relates generally to a method (54) for managing the load space of a delivery vehicle (10), to a load space management system (12) for a load space (14) of a delivery vehicle (10), and to a delivery vehicle (10). A route plan (122) of the delivery vehicle (10) is received from a server (38). A respective load space position (48) at which a respective object (18) which has been introduced or is to be introduced into the load space (14) is to be placed is determined, taking into consideration at least the route plan (122), by an object placement logic (34), before or during the introduction of the respective object (18) into a load space (14) of the delivery vehicle (10). A respective load space position signal is outputted by a signaling device (52). The load space position signal indicates the respective determined load space position (48) for the respective object (18).

### CROSS-REFERENCE TO RELATED APPLICATIONS

The present application claims priority to and the benefit of German Application No. 102023129580.2, filed on Oct. 26, 2023, which is hereby incorporated by reference herein in its entirety.

### FIELD

The disclosure relates generally to a method for managing the load space of a delivery vehicle, to a load space management system for a load space of a delivery vehicle, and to a delivery vehicle.

### BACKGROUND

The drivers of delivery vehicles have various tasks which they must perform, typically multiple times (sometimes more than a hundred times a day), for each delivery trip. These tasks include in particular loading the load space with parcels on the basis of a “mental map”, so that the arrangement of the parcels inside the load space advantageously corresponds in the best possible way to the route plan of the delivery trip. The tasks additionally include sorting the parcels (often) multiple times during the delivery trip and at least locating the parcel corresponding to a delivery location. These repeated steps are very time-consuming.

In order to place the parcels intuitively in the load space, the delivery agent uses a “mental map”, which is based on the number of parcels for this route plan, the parcel size, the parcel volume, the available load space, the distance to be traveled and often further factors. The aim of the “mental map” is to optimize the loading of the load space and also the unloading of the load space in terms of the required lengths of time. However, every delivery agent has his own subjective routine, which is also dependent on the delivery agent's experience. Therefore, consideration of the “mental map” on the one hand represents a burden for the user of the delivery vehicle, and on the other hand it is generally suboptimal, because it is based on a subjective perception of the particular user (delivery agent). Consequently, this causes inefficiencies in the logistics chain, which therefore limit the operational efficiency of the delivery process.

US 2022/0237557 A1 discloses a shipment delivery system which optimizes the routes for parcel delivery. The system is based on coupling each parcel with a sensory device during the sorting process. As a result, however, the system requires additional devices and operations. Furthermore, the sensory devices must be removed again prior to delivery. The system is thus complex.

US 2016/0189087 A1 discloses a system for placing parcels in a load space. A logic determines a load space position for a parcel, which can be indicated to the user by means of an illumination device. The parcels can be detected by means of a barcode scanner. As a result, however, the capabilities of the system both in terms of parcel detection and in terms of load space position determination are limited. The load space is utilized only unsatisfactorily, because the characteristics of the shelf system of the load space are not taken into consideration. Moreover, the delivery trip is dynamic, which can influence the stability of the arrangement of the parcels within the load space. Such influences are not taken into consideration by the system, however.

US 2020/0074404 A1 discloses a delivery vehicle having movable load space portions in order to ensure rapid unloading. However, such delivery vehicles cause high operating expenses.

U.S. Pat. No. 11,377,070 B2 discloses a system for determining a loading of a load space. The dimensions of the parcels and properties of the load space are taken into consideration here. However, many other influences on the optimization of the object placement are ignored as a result.

US 2020/0023755 A1 discloses a generic system for cloud-based communication.

The achievable operational efficiency of the known delivery processes is therefore limited. There is therefore a need to eliminate or at least reduce the disadvantages of known methods and load space management systems. In particular, there is a need to optimize object placement beyond known approaches, in order to optimize the delivery processes by making full use of the object placement.

### SUMMARY

An object is achieved by the subject matter of the independent patent claims. Advantageous embodiments are indicated in the dependent patent claims and in the following description, each of which can represent aspects of the disclosure on its own or in (sub-) combination. Some features are explained in respect of methods, others in respect of devices. The corresponding aspects are, however, correspondingly reciprocally applicable.

In accordance with one aspect, some embodiments of the disclosure relate to a method for managing the load space of a delivery vehicle (ZF). The method has at least the following steps:

A route plan of the ZF is received from a server, in particular by a load space management system (LVS).

Identities of objects which have been introduced or are to be introduced into a load space of the ZF are determined.

A respective load space position at which a respective object which has been introduced or is to be introduced into the load space is to be placed is determined, taking into consideration at least the route plan, by an object placement logic, before or during the introduction of the respective object into the load space of the ZF.

A respective load space position signal is outputted by a signaling device. The load space position signal indicates the respective determined load space position for the respective object.

There is thus provided a method which optionally automatically recognizes objects introduced into the load space, but at least automatically determines the load space positions for the objects which have been introduced or are to be introduced, taking into consideration at least the route plan, but optionally also further information, before or during loading of the load space of the ZF, in order that the delivery operation is optimized. The optimization can in particular be optimized in equal measure in terms of the loading and also the unloading process. In addition, the respective load space position is indicated to the user of the ZF by a signaling device. The user of the ZF is therefore freed of multiple tasks which hitherto had to be performed mentally, such as placement of the objects taking into consideration the route plan. The burden for the user is thus reduced, as a result of which the convenience is increased. In addition, the delivery process is optimized, because it is based on objective criteria, so that the operational efficiency thereof is increased. The method makes it possible, for example, by means of the object placement logic, to determine the optimal way of loading the objects into the ZF in order to permit more flexibility in the allocation of drivers and routes and to increase the efficiency of all the drivers in terms of loading time.

In an alternative, the step of determining the identities of objects introduced into a load space of the ZF can also be omitted. In this case, information at least about the route plan and optionally also further information can be used to determine load space positions for objects which are to be loaded into the load space of the ZF in accordance with the route plan. In particular in this case, the load space positions of the corresponding objects can be determined by an object placement logic before the objects are even introduced into the load space of the ZF.

According to a further aspect, some embodiments of the disclosure relate also to an LVS for a load space of a ZF. The LVS has at least a control device (RV) with a communication device coupled therewith, and a signaling device. The RV is coupled at least with the signaling device. The RV is adapted, by means of the communication device coupled therewith, to receive a route plan of the ZF from a server. The RV has an object placement logic by means of which it is adapted to determine, taking into consideration at least the route plan, a respective load space position at which a respective object which has been introduced or is to be introduced into the load space is to be placed. The RV is adapted, by means of the signaling device, to output a respective load space position signal. The load space position signal indicates the respective determined load space position for the respective object.

The advantages which are achieved by the method described herein are also achieved in a corresponding manner by the LVS.

Preferably, the RV can be adapted, by means of the object placement logic, to determine a respective load space position for an object which is to be introduced into the load space, taking into consideration at least the route plan, before the object is even introduced into the load space of the ZF. This opens up in particular the possibility of determining the load space positions in advance independently of the loading process, for example also with the aid of external components, such as a server, on which parts of the object placement logic can be stored.

Optionally, the RV is adapted, by means of the sensor with which it is coupled, to determine identities of objects introduced into the load space of the ZF, for example using an object identification logic of the RV. The RV can then also determine the load space positions of the objects during or after the introduction of the objects into the load space of the ZF.

A load space can here be understood as being any suitable volume of the ZF, preferably a closed volume, which is suitable for receiving and storing objects.

Load space positions can here be understood as being partial volumes of the load space at which objects can be placed within the load space. In particular, the objects can be capable of being placed at the load space positions such that they typically do not leave the respective load space position, or leave it only negligibly, during the delivery operation of the ZF. Whether they remain permanently at the load space position during the delivery operation of the ZF can additionally depend on the properties of the objects, for example their weight. Load space positions can be defined in relation to further structures of the load space, for example a shelf system arranged inside the load space or compartments thereof. Generally, a load space position is defined within the load space according to a cartesian coordinate system by three relative local coordinates. In addition, however, each load space position also has a certain extent. In this respect, in simplified terms, a cube-shaped volume can be associated with each load space position.

Objects can here be understood as being in particular parcels, items of load or something else that is to be arranged in the load space and transported.

The route plan of a ZF can here be understood as being an information catalog which has delivery locations which correspond to delivery addresses of objects and to which the ZF is to drive in order that the objects can be delivered to the respective delivery locations. Obviously, multiple objects can be associated within the route plan with individual delivery locations, because said objects are to be delivered to the same delivery address. The route plan can, however, also contain information about the objects, for example their dimensions, photographs or representations of the objects and/or their weight.

Preferably, the route plan can be received from the server by means of a wireless communication link, for example a mobile telephone link or a WLAN link. In particular, the communication link can be configured via the internet.

Optionally, the server can be a cloud server, which is adapted to transmit route plans for different ZFs. The server can also have at least one data processing device for preparing the various route plans. The server can further be coupled with a database, which contains information so that the server can prepare or determine the various route plans.

Preferably, the sensor of the LVS is an image acquisition sensor, for example a camera. The camera can be adapted to acquire image data in the visible spectrum. Multiple sensors can of course also be provided, for example multiple cameras. The sensors can together form a sensor system, for example a camera system. Preferably, the cameras of the camera system can have different properties. For example, a first camera can be adapted to acquire RGB data, CYMK data or data of other color tables, that is to say image data which are based on different contrasts, colorations or brightness differences. On the other hand, at least one camera can be adapted to acquire depth information. This means that the camera is adapted to reproduce a distance of an object from the camera in the outputted image data or corresponding data. The image data acquired in each case are transmitted from the cameras of the camera system to the RV of the LVS. The RV can be adapted, on the basis of the received sensor data, to identify different objects, for example parcels but also people.

In some embodiments, the identity of an object is determined by means of an object identification logic of the RV of the LVS. The identity of an object can be determined, for example, on the basis of the external dimensions of the object. Alternatively, the identity can also be identified, for example, on the basis of a barcode or similar serial identifier, such as, for example, a company logo or other imprint arranged on the outer surface of the object. Other properties which can be used to identify an object are the shape, the color or other geometric characteristics which distinguish the object.

In some embodiments, the object identification logic of the RV has an algorithm with machine learning. On the basis of the algorithm, objects are identifiable. The algorithm is capable of distinguishing different properties of the objects from the sensor data of a sensor, for example of a camera. The algorithm can accordingly be trained to distinguish and to identify objects on the basis of the properties. Training of the algorithm can also be effected during ongoing operation. This means that training can be effected not only during individual loading and/or unloading operations but also during extended periods of time over several days or weeks and a high number of loading and/or unloading operations, in order to learn the different properties and continually optimize the object identification logic. A neural network can be used as the basis for the algorithm within the object identification logic of the RV.

Preferably, the object identification logic of the RV is adapted to be executable at least in part as a cloud server mechanism. The RV is able to be coupled with the cloud server. In particular the algorithm forming the basis of the object identification logic can be executable on the cloud server. The RV then transmits the corresponding sensor data of the sensor, for example of the camera, to the cloud server, where they are evaluated in order to identify specific objects within the load space. This creates the possibility of supplying the object identification logic with data from different RVs, which have been acquired in relation to different LVSs. Because the amount of data made available to the object identification logic is thus increased considerably, the decision processes underlying the object identification logic are refined. In particular, the algorithm can thus be trained further by machine learning during operation, as a result of which the confidence of the individual identification of an object is increased.

The RV of the LVS has at least one data processing device. By means of the data processing device, the RV can perform various calculation operations, for example an object identification logic for recognizing and identifying objects arranged in the load space, and an object placement logic for determining load space positions for the objects within the load space of the ZF. Parts of the determination or calculation operations can be relocated to the cloud server. In this case, the RV transmits only corresponding datasets to the cloud server, in order that the cloud server can carry out the corresponding determination operations. The RV then receives from the cloud server data which reflect the result of the respective operations.

Optionally, within the method, a quantity notification is outputted by means of a human-machine interface (MMS). The quantity notification indicates, in respect of the route plan, whether the identities of all the objects or only those of a partial quantity (number), in particular which partial quantity, of the objects forming the basis of the route plan have been determined. The user of the LVS thus receives direct feedback about the quantity of objects introduced into the load space which could be identified automatically by the LVS. The user then simply has to check whether the quantity of identified objects matches the quantity introduced, and thus knows whether additional measures are required. For example, the user can manually detect and identify individual objects and provide the corresponding information for the LVS, so that the LVS then determines a corresponding load space position for an object that was not automatically identified by the LVS. For this purpose, the LVS can have a manually operable sensor device or identification device, for example a scanner. Identification of an object can also be carried out semi-automatically. For example, a user can acquire data of an object, for example by means of the scanner, and transmit these data to the LVS. The LVS can compare the received data with the route plan in order to identify the object. For example, identification of the object can be ensured after a barcode of the object has been captured, since the corresponding data can be stored in the route plan.

The MMS can be a multimedia device of the ZF. The MMS can have at least an image display device and a loudspeaker. Outputting of information by means of the MMS can be effected by means of acoustic (beep, voice, etc.), visual (image on a display, LED strip, lamp, pointer, etc.) or tactile (intelligent items of clothing with corresponding vibration, etc.) indications.

Optionally, the MMS can also be external to the ZF. For example, the MMS can be part of a mobile device which is coupled at least indirectly with the LVS, for example wirelessly. Coupling can optionally be effected via a cloud server. The MMS ensures many different ways of representing the load space and displaying load space positions and of transmitting information, such as, for example, the quantity notifications. These can be adapted in many different ways in order to increase the convenience for the user.

Preferably, the load space position signal is multi-stage. In particular, the signaling device can be multi-component. This means that the load space position signal can first have a coarse signal, which simply indicates that a particular load space position is arranged within a higher-order portion of the load space. In addition, the load space position signal can have a fine signal, which indicates a specific section within the portion defined by the coarse signal. The section can then correspond to a single load space position. Optionally, further increments between the coarse signal and the fine signal are possible. In order to output the various signals, the signaling device can be multi-component. For example, a first light means, for example a lamp, can be used to output the coarse signal. In addition, a second light signal, such as, for example, a laser or an LED strip, can be used to output the fine signal. Alternatively, a single signaling device, which is adapted to output different signal types sequentially and/or simultaneously, can also be used. For example, an emitted laser beam can be split in order to provide different signal types. As a result of the multi-stage configuration of the load space position signal, the identification of a particular load space position is particularly intuitive. The operational efficiency of loading or unloading operations can thus be increased.

In some embodiments, the object placement logic additionally determines the load space position at least on the basis of one of the following:
vehicle information of the ZF;
object properties of the objects forming the basis of the route plan;
stability criteria of the objects in the load space, said stability criteria indicating a load space position reliability of the objects arranged in the load space while the ZF is moving;
a removal distance to be provided at least between some objects;
an estimated time required to load the load space;
an estimated time required to unload the load space;
load space positions of objects introduced into the load space;
a current traffic situation in respect of the route plan;
an expected traffic situation in respect of the route plan at the time of a delivery process according to the route plan; and
route preferences and/or loading preferences of a driver or operator of the ZF.

The vehicle information of the ZF can include in particular a size of the load space, in particular the width, height and length, optionally including local obstructions in the load space, for example wheel cases. The vehicle information can also include an arrangement and dimensions of compartments of a shelf system of the load space, in particular the width, height and length thereof, and also loading limits of the shelf system or of the load compartments thereof. In addition, the vehicle information can include a total loading limit of the delivery vehicle and/or a number of load compartments.

The object properties can include, for example, dimensions of the objects, their weight, their type, such as, for example, roll, cardboard box, bag or envelope, their delivery address and/or their durability.

The stability criteria of the objects in the load space indicate a load space position reliability of the objects arranged in the load space while the ZF is moving. This means that the stability criteria indicate a stable positioning of the objects at their respective load space position. The stable positioning can be influenced, for example, by adjacently arranged objects or also by the packing density. In addition, the stability criteria can also indicate the extent to which a particular object is able to ensure stable positioning for adjacently arranged objects. For example, a lightweight envelope is generally not able ensure stable positioning for adjacently arranged objects. A cube-shaped cardboard box with a minimum weight, on the other hand, is generally very well able to ensure the stable positioning of an object of smaller mass arranged adjacently and in parallel. The stability criteria can additionally also include the orientation of the objects at the load space positions. A cube-shaped object typically has a side with a smallest surface area, a second side, arranged orthogonal thereto, with a largest surface area, and an additional side with a medium surface area. The stable positioning of the object then depends inter alia on the side on which the object is placed at the load space position. The stability criteria thus include many different aspects of the reliability of a distribution of objects at different load space positions in terms of the delivery process as a whole.

The removal distance can be understood as being a distance to be provided at least between some objects in order that the objects can be removed from the load space position by a user. For example, the removal distance can be such that a user is able to clasp an object.

The estimated time required for loading and unloading the load space is to be understood as being the period of time that is necessary for loading or unloading the load space with all the objects according to the route plan.

The object placement logic can also take into consideration existing load space positions of objects. For example, a user may place a particular object at a preferred load space position independently of the LVS, for example because the corresponding object is of higher importance. The object placement logic can then distribute the remaining objects to other load space positions and exclude the blocked load space position from the allocation of further objects. Alternatively, a number of load space positions can also be blocked in another way. The LVS takes such blocked load space positions into consideration and distributes the further objects to the remaining available load space positions.

The current or expected traffic situation can influence the duration of the delivery process as a whole, for example the corresponding unloading operation. In addition, the traffic situation can influence the progression of the ZF, which in turn can influence the stable positioning of objects at load space positions. The traffic situation can thus interact with the stability criteria of the objects in the load space.

The route preferences and/or user preferences can indicate that particular delivery routes are to be taken into consideration. For example, it is known to adapt delivery routes such that (in regions where driving is on the right, e.g. Germany) left turns are avoided where possible. User preferences can indicate, for example, that particularly heavy objects should be arranged at a load space position that is positioned close to an exit of the load space, even if this does not actually appear to be sensible in terms of the route plan. The route preferences and/or user preferences can be based in particular on empirical values, which can be taken into consideration by the object placement logic of the RV of the LVS.

Consequently, the object placement logic is adapted to determine load space positions for the identified objects. The overriding aim of the object placement logic is to optimize the delivery process as a whole. The optimization can be influenced by many factors, as shown by way of example. As a result of the multi-layered consideration of the various factors, the object placement logic of the RV is adapted to determine load space positions for the objects within the load space better than hitherto, such that the efficiency of the delivery process as a whole is increased compared to known approaches. In addition, convenience for the user is increased because, for example, user preferences can also be taken into consideration.

In some embodiments, the object placement logic of the RV has an algorithm with machine learning. On the basis of the algorithm, load space positions for the objects can be determined. The algorithm is capable of taking into consideration different influencing factors for the determination of the particular load space position. The algorithm can also be correspondingly trained for determining the load space position of an object. Training of the algorithm can also be effected during ongoing operation. This means that training can be effected not only during individual loading and/or unloading operations but also during extended periods of time over several days or weeks and a high number of loading and/or unloading operations, in order to learn the different properties and continually optimize the object placement logic. A neural network can be used as the basis for the algorithm within the object placement logic of the RV.

Preferably, the object placement logic of the RV is adapted to be executable at least in part as a cloud server mechanism. The RV is able to be coupled with the cloud server. In particular the algorithm forming the basis of the object placement logic can be executable on the cloud server. The RV then transmits the corresponding sensor data of identified objects and optionally also further information, such as the route plan or the mentioned influencing factors, to the cloud server. In some exemplary embodiments, the data of the identified objects or the at least some influencing factors can also already be present on the cloud server, for example when the cloud server also executes at least in part the object identification logic. This creates the possibility of supplying the object placement logic with data from different RVs, which have been acquired in relation to different LVSs. Because the amount of data made available to the object placement logic is thus increased considerably, the decision processes underlying the object placement logic are refined. In particular, the algorithm can thus be trained further by machine learning during operation, as a result of which the confidence of the individual determination of a load space position of an object is increased.

In some embodiments, load space positions of objects introduced into the load space are detectable by means of at least one sensor. The sensor is coupled with the RV of the LVS. The sensor can be the same sensor as is used to detect objects introduced into the load space. This means that the sensor can also be used to check whether objects are actually arranged at particular load space positions. Thus, for example, it is possible to check even during the delivery process (for example during the trip) whether an object is still arranged at the original load space position. If that is not the case, the RV can update an entry for the object in a corresponding database in terms of its load space position. This makes it possible for an updated load space position signal to be outputted during an operation of unloading the object, so that the user can actually remove the correct object. The efficiency of the delivery operation is thus additionally increased. Furthermore, it can happen that new objects are introduced into the load space according to the route plan even while the delivery process is being carried out, for example because the user of the ZF accepts a return consignment. Because load space positions can be detected by means of the sensor, it can then be determined which load space positions are available at this time and how the newly introduced object is optimally to be arranged within the load space at a particular load space position.

Preferably, the object placement logic is adapted to determine a respective load space position in real time adaptably or repeatedly. The operation of loading the ZF can have multiple individual loading steps, which each comprise the introduction of multiple objects into the load space. The reason for this may be that the user is unable to introduce the total quantity of objects into the load space in a single step. Between these steps, the LVS can repeatedly carry out the determination of the respective load space positions by means of the object placement logic. As a result, the fact that particular load space positions are now no longer available because they are already occupied by objects can be taken into consideration. Alternatively, an updating of the route plan, for example, can have the result that a different distribution of the objects according to changed load space positions is more advantageous. The repeated determination of the load space positions by the object placement logic therefore permits a gain in efficiency.

Optionally, a respective unloading position signal is outputted by a signaling device at a delivery location forming the basis of the route plan. The unloading position signal indicates the respective load space position for the respective object that is to be unloaded from the load space at the delivery location. The signaling device can be the same signaling device as can also output the load space position signal. Thus, rapid location of the object to be unloaded is possible, as a result of which the operational efficiency of the delivery process is increased.

Preferably, the unloading position signal can be multi-stage in a manner corresponding to the load space position signal.

In some embodiments, the load space position likewise indicates an orientation of an object to be placed in the load space. The respective load space position signal additionally indicates the orientation of the respective object. The orientation is here to be understood, for example, as meaning the placement of an object according to a specific orientation, for example placing the object on the side with the smallest surface area. As a result, the packing density can be influenced, in particular increased. In addition, the stability criteria can be influenced if, for example, an object is to be arranged on the side with the largest surface area.

The load space position signal can also be multi-stage, in order additionally to indicate the orientation of the object to be placed in the load space. For example, the load space position signal can have a particular signal sequence by means of which a particular orientation of the object can be coded.

Preferably, the load space position likewise indicates, in dependence on an available load area and the objects forming the basis of the route plan and to be placed in the load space, a stacking of multiple objects to be placed in the load space. The respective load space position signal additionally indicates the stacking of multiple objects to be placed in the load space. As a result, the packing density within the load space can be increased further. For example, stacking of objects is advantageous if multiple objects have the same delivery address and are therefore to be unloaded at the same delivery location. This creates the possibility of removing the objects from the load space together.

Preferably, the LVS has at least one sensor, which is adapted to detect which object is removed from a specific load space position of the load space of the ZF by a user (delivery agent) in the context of an unloading operation. A control device coupled with the sensor can then determine, in dependence at least on the information of a route plan (but optionally also further information, such as a user input) and the data received from the sensor, whether the user removes a correct object according to the route plan from the specific load space position of the load space. For example, there can also be taken into consideration for this purpose information which is stored in a storage device coupled with the control device and which indicates the specific load space position at which the object was positioned when it was loaded into the load space of the ZF. In other words, it is thus possible to determine whether the correct object is removed by a user.

In some embodiments, in dependence on whether the correct or an incorrect object is removed from a load space position by the user, the outputting of a notification, for example by the MMS, can be initiated by the control device. The notification can in particular indicate whether the correct or an incorrect object is/has been removed by the user.

Optionally, the method is designed to be computer-implemented at least in part. This means that the important control mechanics can be executed with the aid of one or more data processing devices.

In accordance with a further aspect, the disclosure relates also to a computer program product comprising commands which, when the program is executed by a computer, cause the computer to carry out the method as described herein. The advantages which are achieved by the method described herein are also achieved in a corresponding manner by the computer program product.

In accordance with an additional aspect, the disclosure relates also to a computer-readable storage medium comprising commands which, when the program is executed by a computer, cause the computer to carry out the method as described herein. The advantages which are achieved by the method described herein are also achieved in a corresponding manner by the computer-readable storage medium.

In some embodiments, the LVS is adapted to carry out the method as described herein.

In accordance with a further aspect, some embodiments of the disclosure relate also to a delivery vehicle having a load space and an LVS as described herein. Within the context of the disclosure, delivery vehicles can include in particular land vehicles, namely inter alia all-terrain and road vehicles such as passenger cars, buses, lorries and other commercial vehicles. Delivery vehicles can be manned or unmanned.

All the features explained in relation to the various aspects can be combined with other aspects individually or in (sub-)combination.

### BRIEF DESCRIPTION OF THE DRAWINGS

The disclosure as well as further advantageous embodiments and developments thereof will be described and explained in greater detail hereinbelow by means of the examples shown in the drawings, in which:

FIG. 1 shows a simplified schematic representation of a delivery vehicle having a load space management system in accordance with an embodiment of the disclosure,

FIG. 2 shows a simplified schematic representation of a method for managing the load space of a delivery vehicle in accordance with an embodiment of the disclosure.

FIG. 3 shows a simplified schematic representation of a method for identifying objects as part of a method for managing the load space of a delivery vehicle in accordance with an embodiment of the disclosure.

FIG. 4 shows a simplified schematic representation of a method for loading a delivery vehicle as part of a method for managing the load space of a delivery vehicle in accordance with an embodiment of the disclosure.

FIG. 5 shows a simplified schematic representation of a method for unloading a delivery vehicle at a delivery location as part of a method for managing the load space of a delivery vehicle in accordance with an embodiment of the disclosure.

FIG. 6 shows a simplified schematic representation of an example of a communication structure of a load space management system in the context of a method for managing the load space of a delivery vehicle in accordance with an embodiment of the disclosure.

FIG. 7 shows a simplified schematic representation of the system components, arranged in the delivery vehicle, of the load space management system in the context of a method for managing the load space of a delivery vehicle in accordance with an embodiment of the disclosure.

FIGS. 8 and 9 show a joint simplified schematic representation of a method for loading a delivery vehicle as part of a method for managing the load space of a delivery vehicle in accordance with an embodiment of the disclosure.

FIG. 10 shows a simplified schematic representation of a method for unloading a delivery vehicle at a delivery location as part of a method for managing the load space of a delivery vehicle in accordance with an embodiment of the disclosure.

FIG. 11 shows a simplified schematic representation of a method for determining load space positions for objects as part of a method for managing the load space of a delivery vehicle in accordance with an embodiment of the disclosure.

FIG. 12 shows a simplified schematic representation of a method for determining load space positions for objects as part of a method for managing the load space of a delivery vehicle in accordance with an embodiment of the disclosure.

FIG. 13 shows a simplified schematic representation of a method for determining load space positions for objects as part of a method for managing the load space of a delivery vehicle in accordance with an embodiment of the disclosure.

FIG. 14A and FIG. 14B show simplified schematic representations of the distribution of objects in a load space of a delivery vehicle as the result of different methods for determining load space positions for objects.

### DETAILED DESCRIPTION

The following detailed description in conjunction with the accompanying drawings, in which the same numerals refer to the same elements, is intended as a description of different embodiments of the disclosed subject matter and is not to represent the individual embodiments. Each embodiment described in this disclosure serves merely as an example or illustration and should not be interpreted as being preferred or advantageous over other embodiments. The illustrative examples contained herein do not claim to be complete and do not limit the claimed subject matter to the exact disclosed forms. Various modifications of the described embodiments are readily identifiable to a person skilled in the art, and the general principles defined herein can be applied to other embodiments and applications without departing from the spirit and scope of the described embodiments. Therefore, the described embodiments are not limited to the embodiments shown but have the largest possible field of application which is compatible with the principles and features disclosed here.

All the features disclosed hereinbelow in relation to the exemplary embodiments and/or the accompanying figures can be combined, on their own or in any desired sub-combination, with features of the aspects of the disclosure, including features of preferred embodiments, provided that the resulting feature combination is meaningful for a skilled person in the technical field.

For the purposes of the disclosure, the wording “at least one of A, B and C” means, for example, (A), (B), (C), (A and B), (A and C), (B and C) or (A, B and C), including all further possible combinations if more than three elements are listed. In other words, the expression “at least one of A and B” means generally “A and/or B”, namely “A” on its own, “B” on its own or “A and B”.

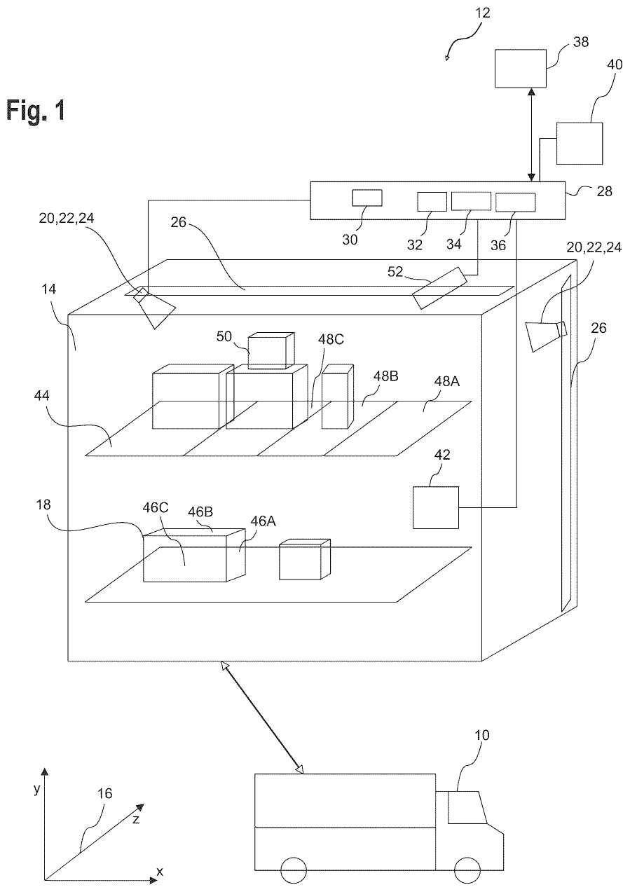

FIG. 1 shows a simplified schematic representation of a delivery vehicle (ZF) 10 having a load space management system (LVS) 12 in accordance with an embodiment of the disclosure.

The LVS 12 is arranged at least in part inside the ZF 10. The ZF has a load space 14. A cartesian coordinate system 16 indicates the orientation of the load space 14 and of the objects 18 arranged therein.

A camera system 20 comprises a plurality of cameras 24 in the form of sensors 22, all the cameras 24 here being displaceably positionable. To this end, the cameras 24 have mounting devices by means of which they can be displaced along different rail devices 26.

The LVS 12 additionally comprises a control device (RV) 28, which has at least a data processing device 30. In accordance with this embodiment, the RV 28 additionally comprises the object identification logic 32 and the object placement logic 34.

The RV 28 is coupled with the cameras 24.

The RV 28 further comprises a communication device 36. By means of the communication device 36, the RV 28 is coupled with a (cloud) server 38. The server 38 can thus be a cloud server. At least parts of the object identification logic 32 and of the object placement logic 34, for example in each case an algorithm with machine learning or underlying neural networks, can also be stored remote from the RV 28, for example within the server 38.

In addition, the RV 28 is coupled with a human-machine interface (MMS) 40. The coupling between the RV 28 and the MMS 40 can be wireless. By means of the MMS 40, the RV 28 can output notifications or receive user inputs.

In addition, the RV 28 is here also coupled with a manually operable sensor device 42, which can be used to manually acquire object data, such as, for example, a barcode. For example, the sensor device 42 can have a scanner. Optionally, the sensor device 42 can also be formed integrally with the MMS 40, for example as part of a mobile device, such as a smartphone.

In accordance with this embodiment, the load space 14 comprises a shelf system 44 by means of which different objects 18 are positioned within the load space 14. The objects 18 typically have different sides 46A, 46B, 46C of different dimensions, in particular different surface area sizes. For example, 46A can denote the smallest side.

The load space 14 has different load space positions 48A, 48B, . . . , with which different parts of the shelf system 44 are associated. In other words, virtual positions are determined (in particular by the RV 28), which are dependent on features of a respective object 18, such as, for example, the size of the object. These virtual positions are associated with a coordinate system in the ZF 10. The load space positions 48 can vary in terms of their dimensions. The load space positions 48 can also have multiple levels of abstraction. This means that a first level of abstraction can denote, for example, the left-hand side of the shelf system 44 within the load space 14. A further level of abstraction can relate to a broad division of the relevant part of the shelf system 44. An additional level of abstraction can relate to the precise arrangement of the load space position within the broad division, that is to say a fine division.

Objects 18 can also be arranged within the load space 14 in the form of a stack 50. All the objects 18 of a stack 50 typically have the same load space position 48. This means that the load space position 48 relates substantially to an available area in the xz-plane of the coordinate system 16. The x-direction here corresponds to the direction of longitudinal extent of the ZF 10, the z-direction to the width of the ZF 10 and the y-direction to the height of the ZF 10. Consequently, the stack 50 has a certain height in the y-direction.

The cameras 24 are adapted to detect objects 18 introduced into the load space 14. The cameras 24 can here also be adapted to detect the load space positions 48 and, for example, also to detect whether objects 18 are arranged at the respective load space position 48. The detection of the load space position 48 can also be effected, for example, in respect of the respective dimensions thereof. This means that, by means of the sensor data acquired in each case, the dimensions of the respective available volumes at the respective load space positions 48 can be determined.

The cameras 24 are in particular positionable by means of the rail devices 26 such that they are able to detect the entire load space 14. To this end, a plurality of rail devices 26 are here arranged orthogonally to one another.

Optionally, one camera 24 of the camera system 16 is adapted to acquire depth information within the load space 14, that is to say a distance of an object 18 from the camera 24.

The image data acquired by the cameras 24 are transmitted to the RV 28. Within the RV 28, or with the aid of external devices, such as, for example, the (cloud) server 38, the RV 28 is adapted to execute the object identification logic 32 and the object placement logic 34.

The LVS 12 also comprises at least one signaling device 52. The signaling device 52 can likewise be displaceable by means of the rail devices 26. The signaling device 52 is coupled with the RV 28. The signaling device 52 is adapted to output a load space position signal, here a visual load space position signal. The load space position signal can be multi-stage and indicate a particular load space position 48, for example at which a particular object 18 is to be arranged. In addition, the load space position signal can also indicate a particular orientation of the object 18 so that the object 18 is arranged on a particular side at a particular load space position 48. Furthermore, the load space position signal can indicate that particular objects 18 are to be arranged at a load space position 48 according to a stack 50.

The signaling device 52 can also be adapted to output an unloading position signal. The unloading position signal can indicate a particular object 18, or a particular load space position 48 at which there is arranged an object 18, that is to be unloaded, that is to say is to be removed, from the load space 14 at that point in time.

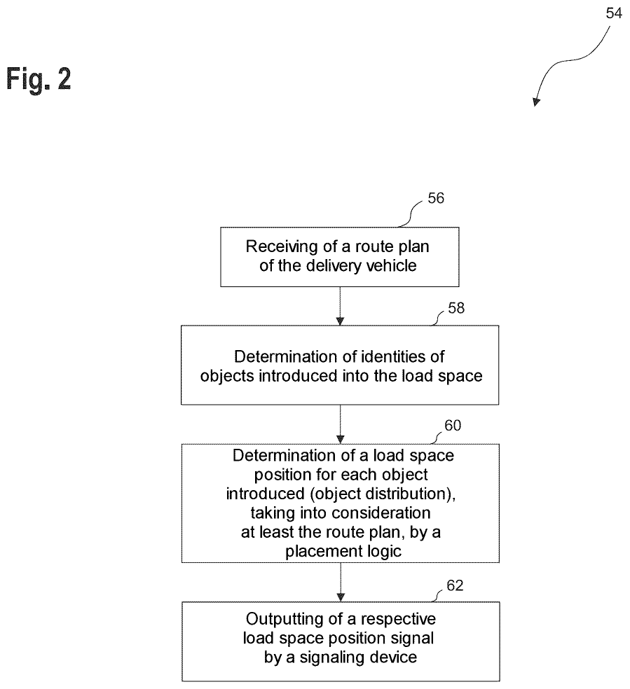

FIG. 2 shows a simplified schematic representation of a method 54 for managing the load space of a ZF 10 in accordance with an embodiment of the disclosure. The embodiment of the method 54 represents a higher-level embodiment with a low level of detail. The method 54 can have additional optional steps and configurations according to the embodiments shown in the further figures.

The method 54 first comprises step 56, in which at least one route plan of the ZF 10 is received from a server, in particular a (cloud) server 38. The route plan can be received in particular by the RV 28 by means of the communication device 36. In the following optional step 58, identities of objects 18 introduced into the load space 14 of the ZF 10 are determined. To this end there can be used, for example, sensor data acquired by means of a sensor 22, in particular a camera 24. By means of the sensor data, the dimensions of the objects 18 or their identification features, such as barcodes, can be determined. These can then be compared, for example, with the route plan, which can contain information about the dimensions or identification features of the objects 18 to be delivered. As a result, the identification of the objects 18 by the RV 28 can be made possible, for example by means of the object identification logic 32. Optionally, step 58 of the method 54 can proceed at least in part in the (cloud) server 38.

In step 60, a respective load space position 48 is determined, taking into consideration at least the route plan, by the object placement logic 34 of the RV 28, namely before or during the introduction of an object 18 into the load space 14 of the ZF 10. An identification of objects 18 that have actually been introduced into the load space 14 is not required for step 60. Instead, the load space positions 48 can also be determined by the object placement logic 34 independently of the actual introduction solely on the basis at least of information of the route plan (and optionally further information). A respective object 18 which has been introduced or is to be introduced into the load space 14 is to be placed at the load space position 48 so determined. The totality of the load space positions 48 so determined forms an object distribution. It is here also possible to take into consideration data acquired by a sensor 22, for example a camera 24. By means of the acquired data, the arrangement and dimensions, for example, of the load space positions 48 within the shelf system 44 can be determined. Optionally, step 60 of the method 54 can proceed at least in part in the (cloud) server 38.

The method 54 also comprises step 62, in which a respective load space position signal is outputted by a signaling device 52. The load space position signal indicates the respective determined load space position 48 for the respective object 18. As a result, the user is assisted in loading the load space 14 with the objects 18, because the user no longer has to locate the load space positions 48 himself. As a result, the operation of loading the load space 14 with the objects 18 can be carried out in shorter periods of time. Thus, the operational efficiency of the delivery process based on the method 54 can be increased.

The method 54 can be carried out in particular by the LVS 12. The following figures show further, more detailed configurations of the method 54, which can be used by the LVS 12 to ensure additional functionalities. The aspects which are explained in relation to different figures can, however, also be combined with one another.

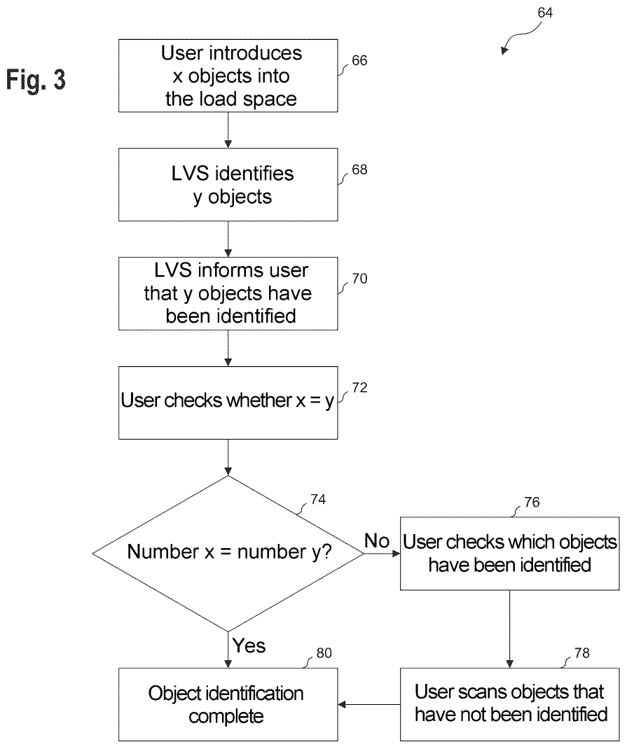

FIG. 3 shows a simplified schematic representation of a method 64 for identifying objects 18 as part of a method 54 for managing the load space of a ZF 10 in accordance with an embodiment of the disclosure. The method 64 shows, by way of example, the functioning of the object identification logic 32 of the RV 28 of the LVS 12.

In step 66 of the method 64, a user introduces a number X of objects 18 into the load space 14 of a ZF 10.

In step 68, the LVS 12 identifies a number Y of objects 18. To this end, sensor data acquired by at least one sensor 22 can be used.

In step 70, the LVS 12 informs the user that a number Y of objects 18 have been identified.

In step 72, the user checks whether the number Y of objects 18 identified by the LVS 12 matches the number X of objects 18 which the user has introduced into the load space 14.

The object identification logic 32 then depends on condition 74, namely whether the number X is equal to the number Y.

If that is not the case, the method 64 comprises the following step 76, in which the user checks which of the objects 18 have been identified by the LVS 12. To this end, the LVS 12 can also initiate a corresponding information output to the user. If complete identification of the objects 18 is not possible, necessary follow-up measures to achieve completeness for the following delivery steps can also be notified to the user by the LVS 12. The corresponding notification can then be outputted, for example, by means of the MMS 40.

Then, in step 78, the user scans the objects 18 that have not been identified by the LVS 12. To this end, the user can use, for example, the manually operable sensor device 42. The data acquired by means of the sensor device 42 are transmitted to the RV 28 of the LVS 12, and in particular to the object identification logic 32.

Once the user has manually scanned all the objects 18 that were not identified automatically by the LVS 12, the object identification according to the object identification logic 32 is complete in step 80. If in condition 74 the number X matches the number Y, step 80 follows immediately as the next step and the object identification according to the method 64 is complete.

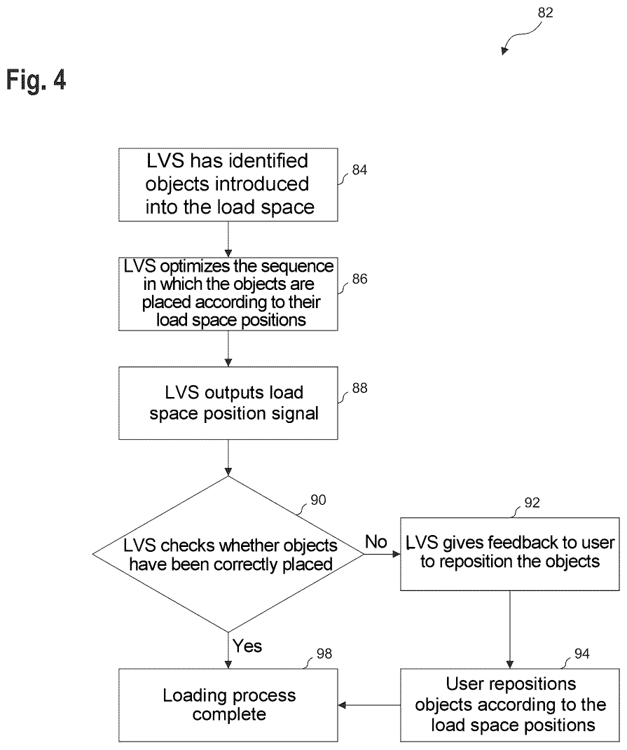

FIG. 4 shows a simplified schematic representation of a method 82 for loading a ZF 10 as part of a method 54 for managing the load space of a ZF 10 in accordance with an embodiment of the disclosure.

In step 84, the LVS 12 has identified objects 18 introduced into the load space 14. To this end, the method 64 of the object identification logic 32, for example, can be used.

In step 86, the LVS 12 optimizes the sequence in which the objects 18 are placed according to the load space positions 48 determined in respect of the objects 18. The corresponding load space positions 48 can be determined, for example, in accordance with step 60 of the method 54.

In the following step 88, the LVS 12 outputs, simultaneously or sequentially, preferably sequentially, load space position signals for all the objects 18 in order to indicate to the user the load space positions 48 at which the objects 18 are to be arranged within the load space 14. The load space position signals are here associated with individual objects 18. For example, the load space position signal can also be adapted to provide the user with information about the object 18 to be placed at a load space position 48, for example by projection of the contours or an identifier. For example, the signaling device 52 can be used for this purpose. Outputting of the load space positions can be carried out, for example, in accordance with step 62 of the method 54.

Within the context of condition 90, the LVS 12 checks whether the objects 18 have been correctly placed within the load space 14 by the user, that is to say according to their determined load space positions 48. To this end, the LVS 12 can use, for example, sensor data acquired by means of the sensors 22.

If not all the objects 18 have been arranged at their respective associated load space positions 48 by the user, then in the following step 92 of the method 82 feedback is outputted to the user by the LVS 12 that at least some, and in particular which, of the objects 18 are to be repositioned in order that the objects 18 are arranged at their respective determined load space positions 48. The feedback to the user can be effected in step 92 by means of the MMS 40, for example.

In the following step 94 of the method 82, the user repositions the objects 18 according to the previously determined load space positions 48. Optionally, step 94 can likewise include the outputting of corresponding load space position signals in order to assist the user in arranging the objects 18 according to the respective associated load space positions 48.

Then, in step 98 of the method 82, the loading process is complete. If it is determined within the context of the checking of condition 90 that the objects 18 have been correctly placed by the user, that is to say according to the respective associated load space positions 48, then the method 82 is continued immediately by the following step 98, which indicates the end of the loading process.

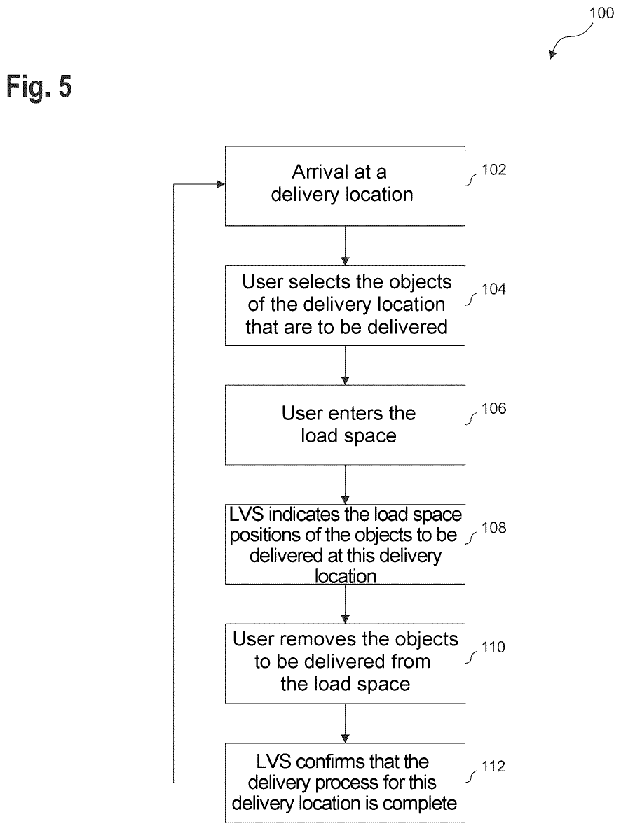

FIG. 5 shows a simplified schematic representation of a method 100 for unloading a ZF 10 at a delivery location as part of a method 54 for managing the load space of a ZF 10 in accordance with an embodiment of the disclosure.

In step 102, the ZF 10 arrives at a delivery location. The delivery location can in particular match a delivery location which is part of a route plan.

In the following step 104, according to this embodiment of the method 100, the user selects objects 18 that are to be delivered at this delivery location.

Then, in step 106 of the method 100, the user enters the load space 14.

In the following step 108, the LVS 12 indicates load space positions of the objects 18 to be removed from the load space 14 at this delivery location. To this end, the signaling device 52 in particular can be used to output corresponding load space position signals. This means that the load space position signals can indicate not only load space positions 48 but also objects 18 in the region of corresponding load space positions 48, in order to indicate either that the objects 18 are to be placed at the load space positions 48 or that the objects 18 are to be removed from the load space positions 48. As a result, the user is assisted in unloading the ZF 10.

In the subsequent step 110, the user removes the objects 18 to be delivered from the load space 14.

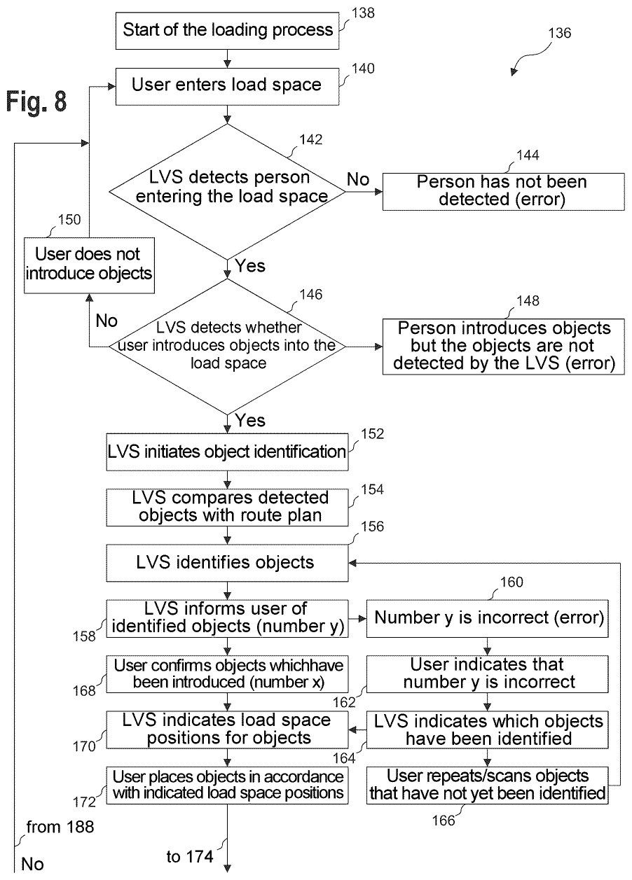

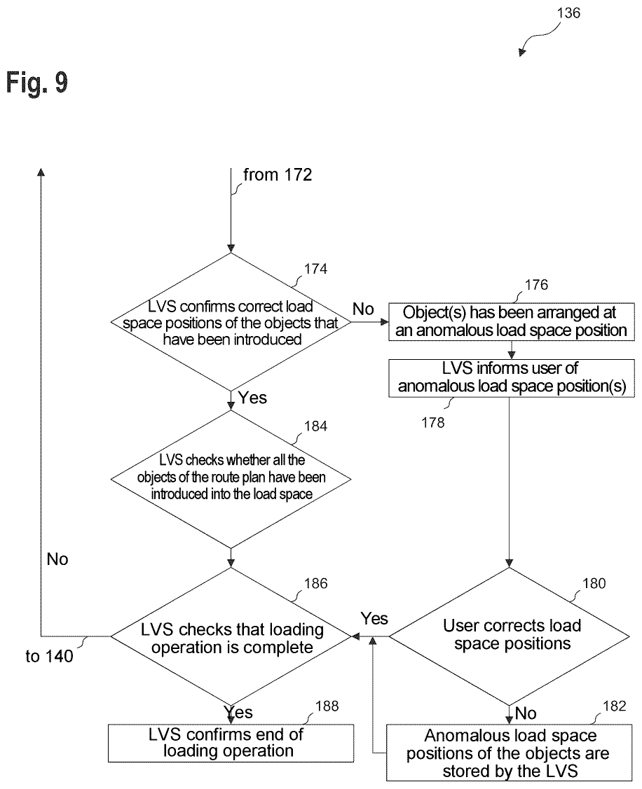

Then, in step 112 of the method 100, the LVS 12 confirms that the delivery process for this delivery location is complete. In particular, the LVS 12 can check, within the context of step 112, whether all the objects 18 selected by the user in step 104 have been removed from the load space 14 (not represented here, but shown by way of example in FIGS. 8 and 9). If that is not the case, a notification can be transmitted to the user by the LVS 12, for example by means of the MMS 40 (not represented here, but shown by way of example in FIGS. 8 and 9).

The method 100 is repeated for each delivery location.

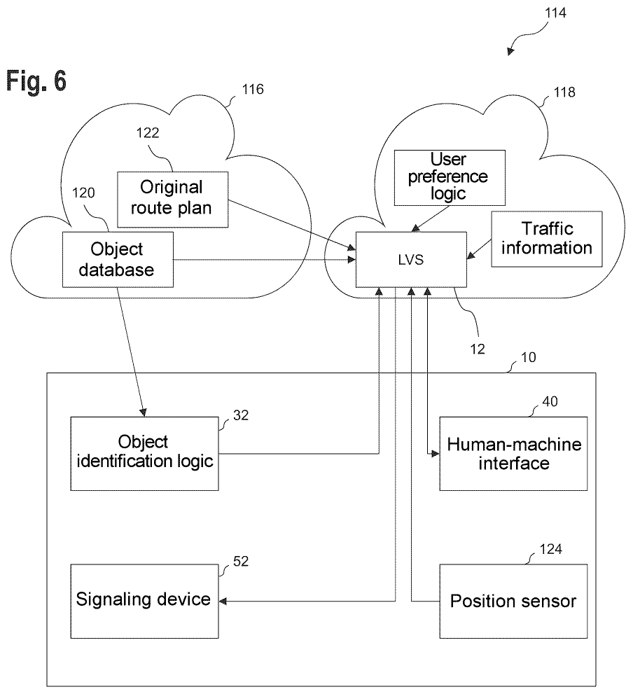

FIG. 6 shows a simplified schematic representation of an example of a communication structure 114 of an LVS 12 within the context of a method 54 for managing the load space of a ZF 10 in accordance with an embodiment of the disclosure.

The figure shows the LVS 12 and how the various components are coupled with one another. The ZF 10 is accordingly coupled with a cloud server 116 of a delivery company (operator of the ZF 10) and with a cloud server 118 of the vehicle manufacturer, for example the Ford Pro Cloud.

The cloud 116 of the delivery company comprises all the information about the objects 18 in an object database 120, for example their dimensions and delivery addresses, as well as the route and updates of the route, that is to say the route plan 122.

In accordance with this embodiment, the cloud server 118 of the vehicle manufacturer comprises the object placement logic 34, which with the aid of artificial intelligence determines the optimal load space position 48 in the load space 14 for each object 18. The entire list of the objects 18 from the object database 120, the route plan 122 and optionally also the user's details regarding his route preferences or the like, as well as previous experience, are here taken into consideration. For example, traffic information can likewise be taken into consideration within the context of the object placement logic 34.

In accordance with this embodiment, the object identification logic 32 of the LVS 12 is arranged within the ZF 10. In addition, the ZF 10 here comprises a position sensor 124 by means of which the position of the ZF 10 can be tracked. Thus, for example, the LVS 12 can detect the arrival of the ZF 10 at a delivery location.

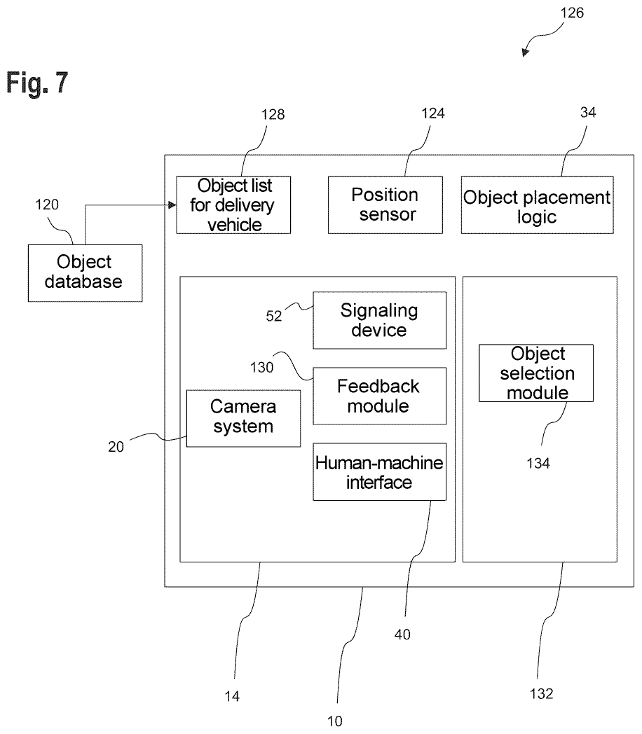

FIG. 7 shows a simplified schematic representation of the system components 126, arranged in the ZF 10, of the LVS 12 in the context of a method 54 for managing the load space of a ZF 10 in accordance with an embodiment of the disclosure.

The object database 120 of the external cloud server 116 of the delivery company provides an object list 128 for the respective ZF 10. In accordance with this embodiment, at least part of the object placement logic 34 is arranged within the ZF 10 as part of the LVS 12.

In the load space 14 there are arranged the camera system 20, at least the signaling device 52, the MMS 40 and a feedback module 130. By means of the feedback module 130, the user can make corresponding inputs for the LVS 12. In some embodiments, the feedback module 130 can also be integral with the MMS 40.

In a cabin region 132 of the ZF 10 there is arranged at least an object selection module 134. By means of the object selection module 134, the user is able to select corresponding objects 18 that are to be unloaded at a delivery location. Optionally, the object selection module 134 can also be integral with the MMS 40. Preferably, the MMS 40 can also be configured as part of a mobile device.

FIGS. 8 and 9 together show a simplified schematic representation of a method 136 for loading a ZF 10 as part of a method 54 for managing the load space of a ZF 10 in accordance with an embodiment of the disclosure. Compared to the method 82, the method 136 has a higher level of detail.

In step 138, the loading process in accordance with the method 136 starts.

In the following step 140, the user enters the load space 14.

The following condition 142 depends on whether the LVS 12 detects the person who enters the load space 14. If that is not the case, the method 136 results according to step 144 in an error, because the person who enters the load space 14 has not been detected. Optionally, the method 136 can provide a user input for this case, which indicates that the user has entered the load space 14. For example, the user input can be effected by means of the MMS 40.

If on checking condition 142 it is determined that the person who enters the load space 14 has been detected by the LVS 12, then it is checked in the following condition 146 whether the user introduces objects 18 into the load space 14.

If the person actually introduces objects 18 into the load space but the objects are not detected by the LVS 12, the method 136 in accordance with this embodiment results in an error according to step 148.

If it is determined within the context of condition 146 that the person does not introduce objects 18 into the load space 14 according to step 150, then the method 136 returns to step 140, and the next entry of a person into the load space 14 is awaited.

If it is determined within the context of condition 146 that the person actually introduces objects 18 into the load space 14, then object identification is initiated by the LVS 12 in the following step 152, for example by means of the object identification logic 32 of the LVS 12.

In the following step 154, the LVS 12 compares detected objects 18, in particular object information thereof, with information from the route plan 122. The object information, such as, for example, the dimensions of an object 18, can be acquired, for example, by a sensor 22.

In the following step 156, objects 18 can be identified by the comparison by means of the LVS 12, for example because the dimensions of a specific object 18 match an entry for an object 18 in the route plan 122. Additional identification mechanisms are based, for example, on the recognition of a barcode.

The method 136 continues with step 158, in which the LVS 12 informs the user of the number Y of identified objects 18. The MMS 40, for example, can be used for this purpose.

If the number Y of identified objects 18 does not match the number X of objects 18 actually introduced into the load space 14, then the method 136 continues with step 160, which indicates that the number Y is incorrect.

In the following step 162, the user indicates that the number Y is incorrect. For example, he can use for this purpose the MMS 40 or the feedback module 130.

Consequently, the LVS 12 indicates in the following step 146 which objects 18 have been identified.

According to the following step 166, the user can then scan objects 18 not yet identified by the LVS 12. For example, he can use the manual sensor device 42 for this purpose. As soon as the user has scanned the objects 18 not identified by the LVS 12, the method 136 returns to step 156.

If the number Y of objects 18 identified by the LVS 12 matches the number X of objects 18 which have actually been introduced, then the method 136 continues, starting from step 158, with step 168. In step 168, the user confirms the number X of objects 18 which have been introduced.

Consequently, in the following step 170, the LVS 12 indicates the load space positions for the identified objects 18. There can be used for this purpose in particular the signaling device 52, in order to output corresponding load space position signals.

Starting from step 164, the LVS 12 can modify the method 136 in order subsequently to carry out step 170, that is to say in order to output the load space positions of the identified objects 18 for the user.

After step 170, the method 136 has the following step 172, in which the user places the objects 18 in accordance with the load space positions indicated by the LVS 12.

Starting from step 172, the method 136 continues with the checking of condition 174, in which the LVS 12 determines whether the objects 18 introduced into the load space 14 have been placed according to the load space positions 48 outputted by the LVS 12. To this end, the LVS 12 can again use, for example, sensor data acquired by means of a sensor 22.

If condition 174 is not met, then the method 136 continues with step 176, which indicates that at least some objects 18 are not arranged at the specified load space positions 48.

Consequently, the LVS 12 informs the user in step 178 of anomalous load space positions 48 of objects 18.

Then, in the following condition 180, it is checked whether the user corrects the load space positions 48 of the relevant objects 18.

If condition 180 is not met, then anomalous load space positions of the objects 18 are stored by the LVS 12 according to the following step 182. To this end, the RV 28 can be coupled, for example, with a storage device.

If condition 174 is met, that is to say the objects 18 have been placed at the allocated load space positions 48, then the LVS 12 checks in the following condition 184 whether all the objects 18 of the route plan have been introduced into the load space 14.

Consequently, the LVS 12 checks in condition 186 whether the loading operation is complete.

If condition 180 is met, that is to say the user has corrected the load space positions 48 of the relevant objects 18, then the method 136 likewise continues with condition 186. Starting from step 182, in which the anomalous load space positions of the objects 18 are stored by the LVS 12, the method 136 likewise continues with condition 186.

If condition 186 is met, that is to say the loading operation is complete, then the LVS 12 confirms the end of the loading operation according to step 188.

If condition 186 is not met, the method 136 comprises, starting from condition 186, a return to step 140. That is to say, the LVS 12 waits for the user to enter the load space 14 again.

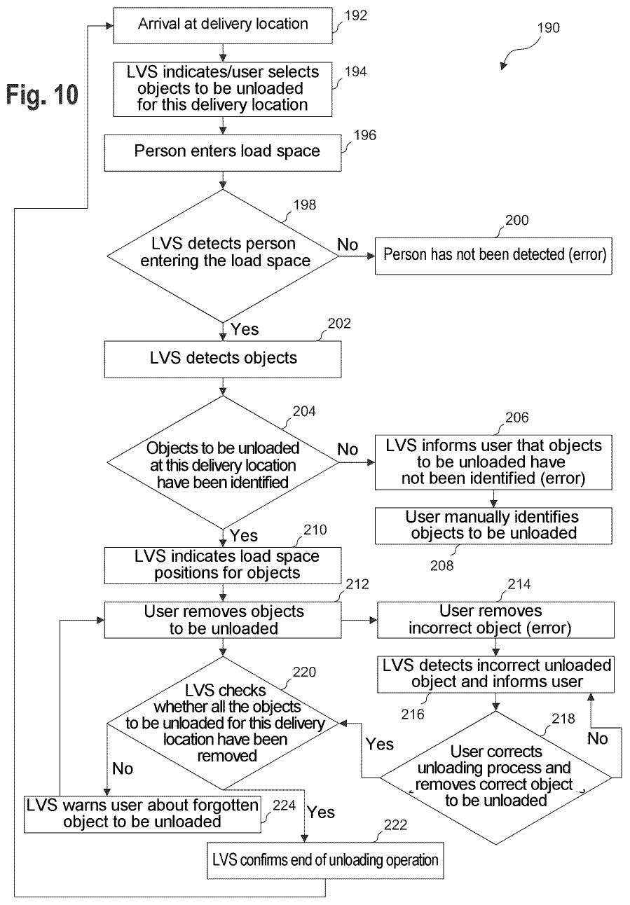

FIG. 10 shows a simplified schematic representation of a method 190 for unloading a ZF 10 at a delivery location as part of a method 54 for managing the load space of a ZF 10 in accordance with an embodiment of the disclosure. Compared to the method 100, the method 190 has a higher level of detail.

In step 192, the ZF 10 arrives at a delivery location. For example, this can be detected by the LVS 12 by means of the position sensor 124.

In the following step 194, the LVS 12 indicates objects 18 to be unloaded for this delivery location. Alternatively, the user can also select objects 18 to be unloaded for this delivery location. For example, this can be effected by means of the object selection module 134.

In the following step 196, the person enters the load space 14.

The method 91 continues with condition 198, which depends on the LVS 12 detecting the person who enters the load space 14.

If condition 198 is not met, then the method 91 results according to step 200 in an error, because the person who enters the load space 14 is not detected by the LVS 12.

If condition 198 is met, then the method 190 continues with the following step 202, in which the LVS 12 detects the objects 18 located in the load space 14.

Condition 204 is then evaluated, namely whether the objects 18 to be unloaded at this delivery location have been identified by the LVS 12.

If condition 204 is not met, then the method 190 continues with step 206 corresponding to an error, in which the LVS 12 informs the user that the objects 18 to be unloaded have not been identified.

Consequently, in the following step 208, the user manually identifies the objects 18 to be unloaded.

If condition 204 is met, then the LVS 12 indicates in the following step 210 the load space positions of the objects 18 to be unloaded. The signaling device 52, for example, can be used for this purpose.

Then, in the following step 212, the user removes the objects 18 to be unloaded from the load space 14.

The method 190 can then continue with step 214 if the user removes an incorrect object 18 from the load space 14, which corresponds to an error.

In this case, the method 190 continues with the following step 216, in which the LVS 12 informs the user of the incorrect unloaded object 18. For example, this can be effected by means of the MMS 40.

The following condition 210 depends on whether the user corrects the unloading process and removes the correct object 18 to be unloaded from the load space 14. If that is not the case, then the method 190, starting from condition 218, returns to step 216.

Starting from step 212, the method 190 can also be continued by the following condition 220, in which the LVS 12 checks whether all the objects 18 to be unloaded for this delivery location have been removed from the load space 14.

If condition 218 is met, that is to say the user corrects the unloading process, then the method 190, starting from condition 218, is likewise continued with condition 220.

If condition 220 is met, that is to say all the objects 18 to be unloaded for this delivery location have been removed from the load space 14, then the LVS 12 confirms the end of the unloading operation in the following step 222. The method 190 then returns to step 192, that is to say the arrival of the ZF 10 at a new delivery location is awaited.

If condition 220 is not met, then the LVS 12 informs the user in the following step 224 of an object 18 for this delivery location that has been forgotten but is to be unloaded. The method 190 then returns, starting from step 224, to step 212.

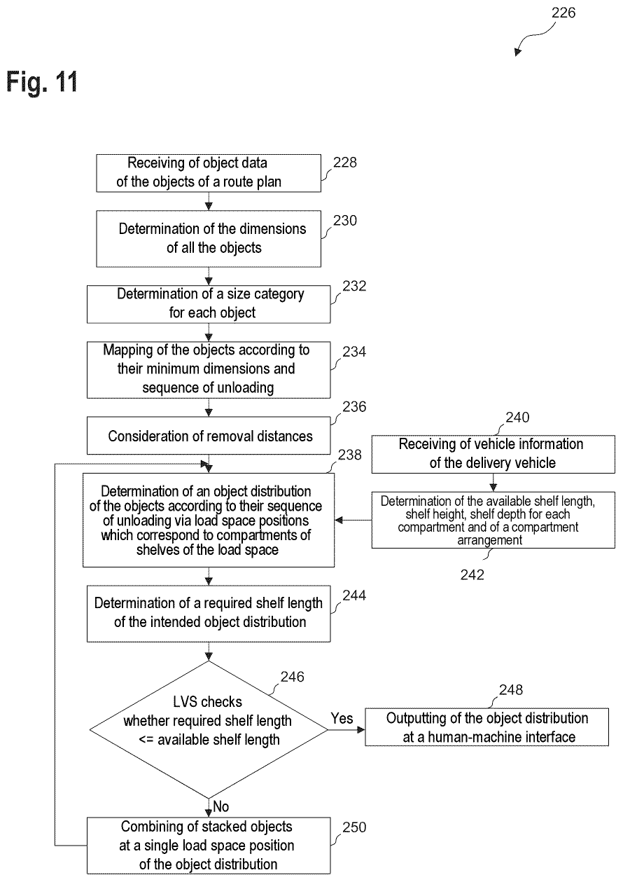

FIG. 11 shows a simplified schematic representation of a method 226 for determining load space positions for objects 18 as part of a method 54 for managing the load space of a ZF 10 in accordance with an embodiment of the disclosure. The method 226 can in particular illustrate by way of example the functioning of the object placement logic 34.

In step 228 of the method 226, object data of the objects 18 of the route plan 122 are received by the LVS 12. To this end, the RV 28 of the LVS 12 can use, for example, the communication device 36, in order to receive the corresponding object data from a server 38.

In the following step 230, the LVS 12 determines the dimensions of all the objects 18.

Then, in the following step 232, a size category for each object 18 is determined by the LVS 12, in particular by the object placement logic 34 thereof. The size category can be determined according to a given distribution, for example small, medium and large. Additional or finer calibrations between the size categories are likewise possible.

In the following step 234, the objects 18 are mapped according to their minimum dimensions and the sequence of unloading. The minimum dimensions relate in particular to a side of smallest extent. For example, a cube-shaped object 18 generally has a side 46A which has the smallest surface area compared to the remaining side faces of the object 18.

The method 226 continues with step 236, in which removal distances between the objects 18 are taken into consideration.

Consequently, in the following step 238, an object distribution of the objects 18 according to their sequence of unloading is determined via load space positions 48. The object distribution has the totality of all the load space positions 48 with which corresponding objects 18 are associated. In other words, the object distribution represents a plan of occupancy of the load space 14 with the totality of the objects 18.

In addition, in accordance with the method 226, vehicle information of the ZF 10 is received by the LVS 12 according to step 240, for example from a (cloud) server 38.

In the following step 242, an available shelf length of the load space 14 in the X direction of a cartesian coordinate system 16, that is to say in the direction of longitudinal extent of the vehicle, is determined by the LVS 12 on the basis of the received vehicle information. In addition, an available shelf height in the Y direction and an available shelf depth in the Z direction are also determined by the LVS 12 for each compartment of the shelf system 44. The dimensions of the respective load space positions 48 can be determined therefrom. This information is taken into consideration, starting from step 242, in step 238.

Following step 238, the method 226 continues with step 244, in which a required shelf length of the intended object distribution is determined by the LVS 12.

According to the following condition 246, the LVS 12 checks whether the required shelf length from step 244 is smaller than or at least equal to the available shelf length determined according to step 242.

If condition 246 is met, then the determined object distribution of the objects 18 is outputted for the user at the MMS 40 according to step 248. The object distribution can comprise a sequential outputting of individual entries of the object distribution. Alternatively, the object distribution can also be outputted in its entirety by means of the MMS 40.

If condition 246 is not met, then method 226 continues with step 250. In step 250, stacked objects 18 are allocated to individual load space positions 48 of the object distribution on the basis of individual stacks 50. This means that multiple objects 18 are to be arranged at a single load space position 48 by the formation of a stack 50. Starting from step 250, the method 226 then comprises a return to step 238.

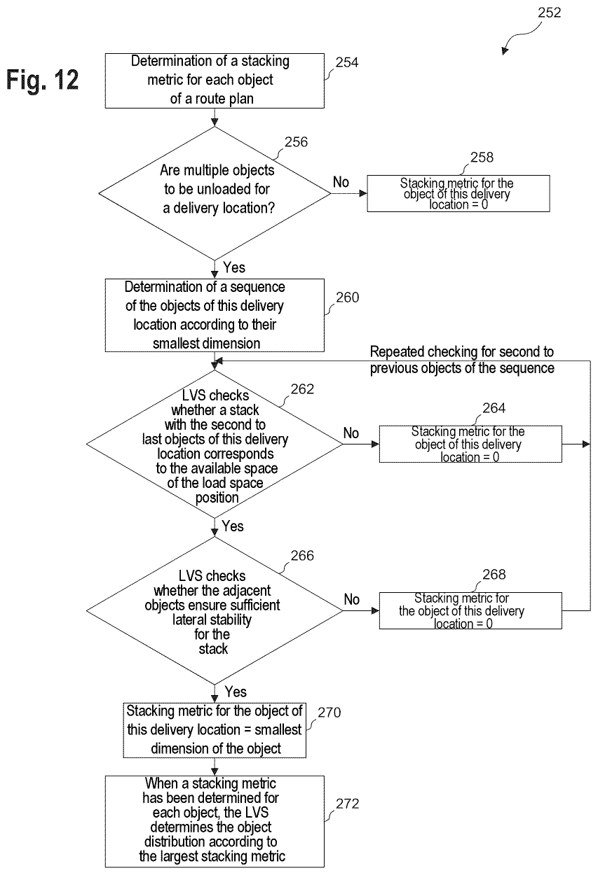

FIG. 12 shows a simplified schematic representation of a method 252 for determining load space positions for objects 18 as part of a method 54 for managing the load space of a ZF 10 in accordance with an embodiment of the disclosure. The method 252 can in particular illustrate by way of example the functioning of the object placement logic 34. The method 252 is carried out repeatedly in relation to individual delivery locations. For each delivery location, the totality of the objects 18 to be unloaded at the delivery location is generally taken into consideration.

Method 252 begins with step 254, in which a stacking metric is determined by the LVS 12 for each object 18 of a route plan 122. The stacking metric indicates how a corresponding object 18 is to be oriented at a particular load space position 48. For example, the stacking metric can indicate whether an object 18 is to be placed on the side with the smallest surface area (small stacking metric). On the other hand, the stacking metric can indicate whether an object 18 is to be placed on the side with the largest surface area (large stacking metric). This has an influence, for example, on the stable positioning of the object 18 during the delivery process.

The method 252 then continues with condition 256, in which the LVS 12 checks whether multiple objects 18 are to be unloaded for a delivery location.

If that is not the case, in the following step 258 the stacking metric for the relevant object 18 of this delivery location is set to 0. This means that the object 18 in question does not have a stacking metric, that is to say stacking has hitherto been ruled out.

If condition 256 is met, then the method 252 continues with step 260, in which a sequence of the objects 18 of this delivery location is determined by the LVS 12 according to in each case the smallest dimensions of the objects 18 of this delivery location. The smallest dimensions generally relate to the sides with the smallest side faces.

In the following condition 262, the LVS 12 checks whether a stack 50 with the second to last objects 18 of this delivery location corresponds to the available space of the intended load space position 48 according to the sequence determined in step 260. In other words, a single load space position 48 is allocated to this delivery location, and it is checked whether a stack 50, which contains the second to last objects of the determined sequence, corresponds to an available volume of the load space position 48.

If condition 262 is not met, then the stacking metric is set to 0 according to step 264. This means that the object 18 in question does not have a stacking metric, that is to say the formation of a stack has hitherto been ruled out. The method 252 then returns to condition 262, wherein, however, condition 262 is now carried out repeatedly, but only in respect of the second to penultimate objects 18 of the sequence determined in step 260. The loop between condition 262 and step 264 can be effected repeatedly, wherein the check is in each case reduced by an object 18 of the sequence determined in step 260, namely starting in each case from the last object 18 of the sequence.

If condition 262 is met, the LVS 12 checks in the following condition 266 whether the objects 18 arranged adjacent to the intended load space position 48 ensure sufficient lateral stability for the stack 50.

If condition 266 is not met, the method 252 continues with step 268, in which the stacking metric for the considered object 18 of this delivery location is set to 0. This means that the object 18 in question does not have a stacking metric, that is to say the formation of a stack has hitherto been ruled out. The method 252 then comprises a return, starting from step 268, to condition 262, wherein the checking of condition 262 is likewise effected for in each case a reduced number of objects 18, as has already been explained with regard to the loop between condition 262 and step 264. This means that the loops between condition 262, condition 266 and step 268 are carried out repeatedly, wherein the check is in each case reduced by an object 18 of the sequence determined in step 260, namely starting in each case from the last object 18 of the sequence.

If condition 266 is met, then the method 252 continues with step 270, in which the stacking metric for the object 18 of this delivery location is specified as the smallest dimension of the object 18. The smallest dimension of the object 18 is again generally to be understood as being the side with the smallest surface area.

In the following step 272, the LVS 12 determines the object distribution according to the largest stacking metric, provided that a stacking metric has been determined at this time for each object 18. The object distribution so determined can then be outputted, for example by means of the MMS 40. By selecting the largest stacking metric, it is ensured that the objects 18 are preferably placed on their largest sides. As a result, stability during the delivery process, for example stable positioning while the ZF 10 is moving, is increased.

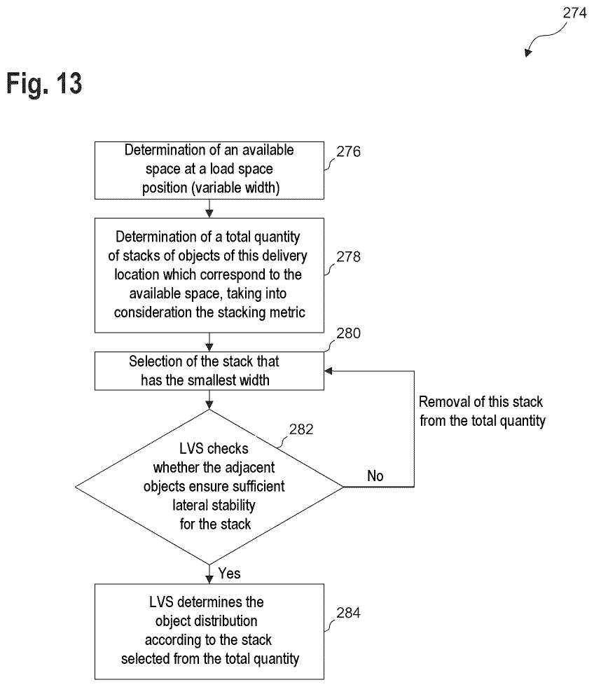

FIG. 13 shows a simplified schematic representation of a method 274 for determining load space positions for objects 18 as part of a method 54 for managing the load space of a ZF 10 in accordance with an embodiment of the disclosure. The method 274 can in particular illustrate by way of example the functioning of the object placement logic 34. The method 274 is carried out jointly for all objects 18 of a single delivery location.

The method 274 begins with step 276, in which an available space at a load space position 48 is determined by the LVS 12, taking into consideration a variable width in the X direction, that is to say in the direction of longitudinal extent of the ZF 10.

In the following step 278, a total quantity of stacks 50 of objects 18 of this delivery location which correspond to the available space determined in step 276 at these load space positions 48 is determined by the LVS 12, wherein the stacking metric is taken into consideration. In other words, the possible combinations of objects 18 are determined according to different stacks 50 for which the available volume of the corresponding load space position 48 is sufficient.

In the following step 280, the stack 50 that has the smallest width is selected by the LVS 12. The width of the stack 50 here relates to the X direction of the coordinate system 16, that is to say to the direction of longitudinal extent of the ZF 10.

In the subsequent condition 282, the LVS 12 checks whether the adjacent objects 18 of the corresponding load space positions 48 ensure sufficient lateral stability for the stack 50 selected in step 280.

If condition 282 is not met, then the method 274 comprises a return to step 280, wherein, however, the stack 50 previously selected in step 280 is removed from the total quantity of available stacks 50 for these load space positions 48. Thus, only the remaining stacks 50 of the total quantity of stacks 50 are checked.

If condition 282 is met, the method 274 continues with step 284, in which the LVS 12 determines the object distribution according to the stacks 50 selected from the total quantity.

The object distribution can subsequently be outputted in known manner, for example via an MMS 40.

The methods 226, 252, 284 can in particular be part of the method 54 for managing the load space of a ZF 10 in accordance with an embodiment of the disclosure. The methods 226, 252, 274 can in particular be taken into consideration by the object placement logic 34 in step 60 of the method 54.

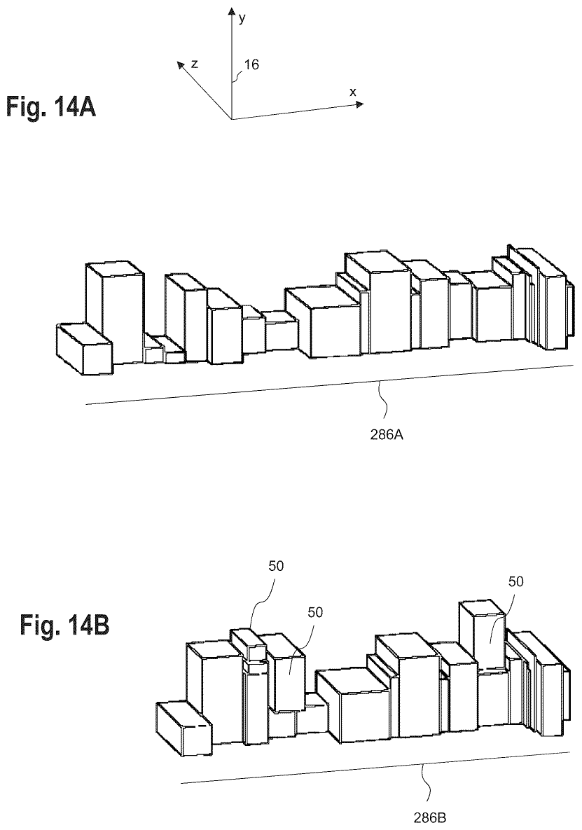

In connection with the methods 252, 274 of FIGS. 12 and 13, FIG. 14A and FIG. 14B show simplified schematic representations of object distributions of objects 18 in a load space 14 of a ZF 10 as a result of different methods for determining load space positions for objects 18. In FIG. 14A, stacking of objects 18 is ruled out. All the objects 18 are arranged side by side in the X direction of the coordinate system 16, that is to say in the direction of longitudinal extent of the ZF 10. This has the result that the objects 18 occupy a joint load space length 286A.

In FIG. 14B, in particular the possibility of forming stacks of objects 18 is taken into consideration, for example by means of the methods 252, 274. It is here ensured that objects 18 arranged adjacent to stacks 50 ensure sufficient lateral stability for the respective stack 50. Consequently, the object distribution, that is to say the totality of the objects 18 arranged in the load space 14, requires only a reduced load space length 286B, which in particular is smaller than the load space length 286A of the object distribution of FIG. 14A. The packing density within the load space 14 can thus be increased.

Specific embodiments disclosed here, in particular the control device, use circuits (e.g. one or more circuits) in order to implement standards, protocols, methods or technologies disclosed here, to couple two or more components in a functional manner, to generate information, to process information, to analyze information, to generate signals, to code/decode signals, to convert signals, to transmit and/or to receive signals, to control other devices, etc. Circuits of any type can be used.

In one embodiment, a circuit such as the control device comprises inter alia one or more data processing devices such as a processor (e.g. a microprocessor), a central processing unit (CPU), a digital signal processor (DSP), an application-specific integrated circuit (ASIC), a field-programmable gate array (FPGA), a system on a chip (SoC) or the like or any desired combinations thereof and can comprise discrete digital or analog switching elements or electronics or combinations thereof. In one embodiment, the circuit comprises hardware circuit implementations (e.g. implementations in analog circuits, implementations in digital circuits and the like as well as combinations thereof).

In one embodiment, circuits comprise combinations of circuits and computer program products with software or firmware instructions, which are stored on one or more computer-readable memories and interact in order to cause a device to execute one or more of the protocols, methods or technologies described here. In one embodiment, the circuit technology comprises circuits, such as, for example, microprocessors or parts of microprocessors, which require software, firmware and the like for operation. In one embodiment, the circuits comprise one or more processors or parts thereof and the associated software, firmware, hardware and the like.

In this disclosure, reference may be made to quantities and numbers. Unless stated explicitly, such quantities and numbers are not to be considered to be limiting but rather as examples of the quantities or numbers that are possible in connection with the disclosure. In this connection, the term “plurality” may also be used in the disclosure to refer to a quantity or number. In this connection, the term “plurality” means any number greater than one, for example two, three, four, five, etc. The terms “about”, “approximately”, “close to”, etc. mean plus or minus 5% of the indicated value.

Although the disclosure has been represented and described in relation to one or more embodiments, a person skilled in the art, after reading and understanding this description and the accompanying drawings, will be able to make equivalent changes and modifications.

We claim:

1. A method for managing the load space of a delivery vehicle, wherein the method includes at least the following steps:
receiving of a route plan of the delivery vehicle from a server,
determining a respective load space position at which a respective object which has been introduced or is to be introduced into the load space is to be placed,
taking into consideration at least the route plan before or during the introduction of the respective object into a load space of the delivery vehicle, and
outputting of a respective load space position signal by a signaling device, wherein the load space position signal indicates the respective determined load space position for the respective object.

2. The method of claim 1, further including:
determining identities of objects introduced into a load space of the delivery vehicle.

3. The method of claim 2, wherein a quantity notification is outputted by a human-machine interface, wherein the quantity notification indicates, in respect of the route plan, whether the identities of all the objects or a partial quantity of the objects forming the basis of the route plan have been determined.

4. The method of claim 1, wherein a first load space position signal is multi-stage.

5. The method of claim 1, wherein determining the load space position is based on one or more of the following:
vehicle information of the delivery vehicle,
object properties of the objects forming the basis of the route plan, stability criteria of the objects in the load space, said stability criteria indicating a load space position reliability of the objects arranged in the load space while the delivery vehicle is moving,
a removal distance to be provided at least between two objects,
an estimated time required to load the load space,
an estimated time required to unload the load space,
load space positions of objects introduced into the load space,
a current traffic situation in respect of the route plan,
an expected traffic situation in respect of the route plan at the time of a delivery process according to the route plan, or
route preferences or loading preferences of a driver or operator of the delivery vehicle.

6. The method of claim 1, wherein the load space positions of objects introduced into the load space are detectable by at least one sensor.

7. The method of claim 1, wherein determining a respective load space position is in real time adaptably or repeatedly.

8. The method of claim 1, wherein a respective unloading position signal is outputted by a signaling device at a delivery location forming the basis of the route plan, wherein the unloading position signal indicates the respective load space position for the respective object that is to be unloaded from the load space at the delivery location.

9. The method of claim 1, wherein the load space position indicates an orientation of an object to be placed in the load space, and wherein the respective load space position signal additionally indicates the orientation of the respective object.

10. The method of claim 1, wherein the load space position indicates, in dependence on an available load area and the objects forming the basis of the route plan and to be placed in the load space, a stacking of multiple objects to be placed in the load space, and wherein the respective load space position signal additionally indicates the stacking of multiple objects to be placed in the load space.

11. The method of claim 1, wherein determining the load space positions is computer-implemented.

12. A load space management system for a load space of a delivery vehicle, wherein the load space management system comprises:
a control device;
a communication device coupled to the control device; and
a signaling device coupled to the control device,
wherein the control device is configured to perform the steps of:
receive a route plan of the delivery vehicle from a server,
determine, based at least in part on the route plan, before or during the introduction of a respective object into a load space of the delivery vehicle, a load space position at which the respective object which has been introduced or is to be introduced into the load space is to be placed, and
output, using the signaling device, a respective load space position signal, wherein the load space position signal indicates the respective determined load space position for the respective object.

13. The load space management system of claim 12, wherein determining the load space position is based on one or more of the following:
vehicle information of the delivery vehicle,
object properties of the objects forming the basis of the route plan, stability criteria of the objects in the load space, said stability criteria indicating a load space position reliability of the objects arranged in the load space while the delivery vehicle is moving,
a removal distance to be provided at least between two objects,
an estimated time required to load the load space,
an estimated time required to unload the load space,
load space positions of objects introduced into the load space,
a current traffic situation in respect of the route plan,
an expected traffic situation in respect of the route plan at the time of a delivery process according to the route plan, or
route preferences or loading preferences of a driver or operator of the delivery vehicle.

14. The load space management system of claim 12, wherein a quantity notification is outputted by a human-machine interface, wherein the quantity notification indicates, in respect of the route plan, whether the identities of all the objects or a partial quantity of the objects forming the basis of the route plan have been determined.

15. The load space management system of claim 12, wherein the load space position indicates an orientation of an object to be placed in the load space, and wherein the respective load space position signal additionally indicates the orientation of the respective object.

16. The load space management system of claim 12, wherein the load space position indicates, in dependence on an available load area and the objects forming the basis of the route plan and to be placed in the load space, a stacking of multiple objects to be placed in the load space, and wherein the respective load space position signal additionally indicates the stacking of multiple objects to be placed in the load space.

17. A delivery vehicle having a load space management system, wherein the load space management system comprises:
a control device;
a communication device coupled to the control device; and
a signaling device coupled to the control device,
wherein the control device is configured to perform the steps of,
receive a route plan of the delivery vehicle from a server,
determine, based at least in part on the route plan, before or during the introduction of a respective object into a load space of the delivery vehicle, a load space position at which the respective object which has been introduced or is to be introduced into the load space is to be placed, and
output, using the signaling device, a respective load space position signal, wherein the load space position signal indicates the respective determined load space position for the respective object.

18. The delivery vehicle of claim 17, wherein determining the load space position is based on one or more of the following:
vehicle information of the delivery vehicle;
object properties of the objects forming the basis of the route plan;
stability criteria of the objects in the load space, said stability criteria indicating a load space position reliability of the objects arranged in the load space while the delivery vehicle is moving;
a removal distance to be provided at least between two objects;
an estimated time required to load the load space;
an estimated time required to unload the load space;
load space positions of objects introduced into the load space;
a current traffic situation in respect of the route plan;
an expected traffic situation in respect of the route plan at the time of a delivery process according to the route plan; or
route preferences or loading preferences of a driver or operator of the delivery vehicle.

19. The delivery vehicle of claim 17, wherein a quantity notification is outputted by a human-machine interface, wherein the quantity notification indicates, in respect of the route plan, whether the identities of all the objects or a partial quantity of the objects forming the basis of the route plan have been determined.

20. The delivery vehicle of claim 17, wherein the load space position indicates an orientation of an object to be placed in the load space, and wherein the respective load space position signal additionally indicates the orientation of the respective object.
